(19) United States
(12) Patent Application Publication
(10) Pub. No.: US 2026/0105576 A1
(43) Pub. Date: Apr. 16, 2026

(54) IMAGE PROCESSING DEVICE, IMAGE PROCESSING METHOD, AND PROGRAM

(71) Applicant: Panasonic Intellectual Property Management Co., Ltd., Osaka (JP)

(72) Inventors: HIROMU KITAJIMA, Hyogo (JP); MOTOTAKA YOSHIOKA, Osaka (JP); SOUKSAKHONE BOUNYONG, Osaka (JP)

(21) Appl. No.: 19/124,311

(22) PCT Filed: Nov. 8, 2023
(86) PCT No.: PCT/JP2023/040227

§ 371 Date: Apr. 25, 2025

(30) Foreign Application Priority Data
Dec. 2, 2022 (JP) 2022-193694

(51) Int. Cl. G06T 5/50; G06V 10/74; G06V 10/77

(52) U.S. Cl. CPC G06T 5/50; G06V 10/761; G06V 10/7715; G06T 2207/20221

(57) ABSTRACT

Provided is an image processing device that enables a user to easily select an image to be newly learned. Image processing device includes learning part, acquisition part, and display controller. Learning part learns an image by using deep learning. Acquisition part acquires a first feature amount of each of a first image and a second image extracted in a first layer in deep learning, and a second feature amount of each of a first image and a second image extracted in a second layer different from the first layer in deep learning. Display controller superimposes and displays first feature amount information on a first feature amount and a second feature amount extracted from a first image on the first image, and superimposes and displays second feature amount information on the first feature amount and the second feature amount extracted from the second image on the second image.

### TECHNICAL FIELD

The present disclosure relates to an image processing device, an image processing method, and a program.

### BACKGROUND ART

Conventionally, there is a device that extracts a feature amount at a feature point of an image. For example, Patent Literature 1 discloses a program for obtaining a combination having high stability of feature amounts from two images to be compared.

Conventionally, there is a technique for displaying a plurality of images on a display device. For example, Patent Literature 2 discloses a device that performs different processing on a plurality of input images and outputs the processed images.

### CITATION LIST

### Patent Literature

PTL 1: Unexamined Japanese Patent Publication No. 2018-142189
PTL 2: International Publication No. WO 2018/003939

### SUMMARY OF THE INVENTION

Conventionally, there is a learning model that performs machine learning using an image showing a target object for analysis of the target object or the like. Here, for example, in a case where the learned learning model is caused to perform learning again, there are an image effective for learning (that is, highly necessary to perform learning again) and an image not effective for learning. Therefore, for example, the user checks the image and selects an image to be relearned by the learning model. Therefore, it is desired that the user can easily select an image to be newly learned.

The present disclosure provides an image processing device, an image processing method, and a program that allow a user to easily select an image to be newly learned.

An image processing device according to one aspect of the present disclosure includes: a learning part that learns an image by using deep learning, an acquisition part that acquires a first feature amount of each of a first image and a second image extracted in a first layer in the deep learning and a second feature amount of each of a first image and a second image extracted in a second layer different from the first layer in the deep learning; and a display controller that superimposes and displays first feature amount information on the first feature amount and the second feature amount extracted from the first image on the first image and superimposes and displays second feature amount information on the first feature amount and the second feature amount extracted from the second image on the second image.

An image processing method according to another aspect of the present disclosure includes: a learning step of learning an image by using deep learning; an acquisition step of acquiring a first feature amount of each of a first image and a second image extracted in a first layer in the deep learning and a second feature amount of each of a first image and a second image extracted in a second layer different from the first layer in the deep learning; and a display control step of superimposing and displaying first feature amount information on the first feature amount and the second feature amount extracted from the first image on the first image, and superimposing and displaying second feature amount information on the first feature amount and the second feature amount extracted from the second image on the second image.

A program according to another aspect of the present disclosure is a program for causing a computer to execute the image processing method according to one aspect of the present disclosure.

According to the image processing device, the image processing method, and the program of the present disclosure, it is possible to provide the image processing device, the image processing method, and the program that enable the user to easily select an image to be newly learned.

### BRIEF DESCRIPTION OF THE DRAWINGS

FIG. 1 is a block diagram illustrating a configuration of an image processing device according to an exemplary embodiment.

FIG. 2 is a diagram for describing a learning part according to the exemplary embodiment.

FIG. 3 is a view for describing a first example of an image displayed on a display according to the exemplary embodiment.

FIG. 4 is a view for describing a second example of an image displayed on the display according to the exemplary embodiment.

FIG. 5 is a view for describing a third example of an image displayed on the display according to the exemplary embodiment.

FIG. 6 is a view for describing a fourth example of an image displayed on the display according to the exemplary embodiment.

FIG. 7 is a view for describing a fifth example of an image displayed on the display according to the exemplary embodiment.

FIG. 8 is a flowchart illustrating a processing procedure of image display processing of the image processing device according to the exemplary embodiment.

FIG. 9 is a flowchart illustrating a processing procedure of learning processing of the image processing device according to the exemplary embodiment.

FIG. 10 is a flowchart illustrating a specific example of a processing procedure of learning processing of the image processing device according to the exemplary embodiment.

FIG. 11 is a flowchart illustrating a processing procedure for determining whether or not to execute learning processing of the image processing device according to the exemplary embodiment.

FIG. 12 is a flowchart illustrating a processing procedure of the image processing device according to the exemplary embodiment.

### DESCRIPTION OF EMBODIMENT

Hereinafter, an exemplary embodiment of the present disclosure will be described with reference to the drawings. Note that the exemplary embodiment described below illustrates a specific example of the present disclosure. Therefore, numerical values, shapes, materials, components, arrangement positions and connection modes of the components, and the like shown in the following exemplary embodiments are merely examples, and are not intended to limit the present disclosure. Accordingly, among the components in the exemplary embodiment below, a component not described in an independent claim will be described as an optional component.

Each drawing is a schematic diagram, and is not necessarily strictly illustrated. In each drawing, substantially the same components are denoted by the same reference numerals, and redundant description will be omitted or simplified.

### EXEMPLARY EMBODIMENT

### [Configuration]

First, a configuration of image processing device 100 according to the exemplary embodiment will be described.

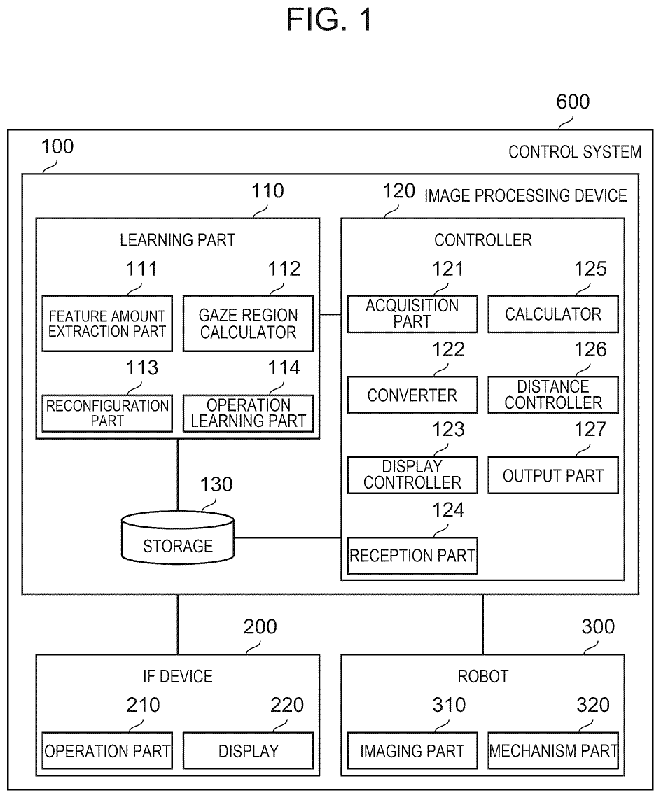

FIG. 1 is a block diagram illustrating a configuration of image processing device 100 according to the exemplary embodiment.

The image processing device 100 is a device that performs machine learning on an image generated by an imaging device such as a camera imaging a target object (workpiece). Specifically, in order to control the operation of robot 300 on the basis of the image, image processing device 100 performs machine learning (more specifically, deep learning) so that a feature amount can be appropriately extracted from the image. For example, the learning model is caused to perform machine learning based on various images (learning images) obtained by imaging a target object and information (annotation information) indicating a feature amount for each learning image.

In control system 600 including image processing device 100, interface device (IF device) 200, and robot 300, image processing device 100 controls the operation of robot 300 by using a learning model on the basis of an image generated by robot 300 imaging a target object. Furthermore, image processing device 100 controls IF device 200 to display an image, and causes the learning model to relearn on the basis of an instruction from the user acquired via IF device 200.

In the present specification, machine learning (deep learning) is also simply referred to as learning.

Here, the learning image includes an image that can effectively cause the learning model to perform learning. In general, it is necessary to prepare images of various variations as learning data for learning of the learning model. However, even if the image is an image that has not been learned by the learning model, there is a case where the learning model already has performance capable of correctly inferring the image due to generalization of the learning model by learning. In this way, it is less necessary to cause the learning model to relearn an image that is already correctly inferred. For example, the user checks the image, selects an image to be relearned by the learning model, and causes the learning model to learn the selected image.

Therefore, for example, image processing device 100 displays an image that the learning model can correctly infer and an image that the learning model cannot correctly infer so that the user can easily distinguish the images from each other among a plurality of images that the learning model has not learned, and causes the learning model to relearn only the image that the learning model cannot correctly infer. As described above, in order to reduce the learning data for relearning by the learning model, image processing device 100 displays an image so that the user can easily select an image to be newly learned.

Note that the performance referred to herein is, for example, a capability of correctly extracting a feature amount when an image is input to a learned learning model.

The target object is an object appearing in an image input to the learning model. The target object is, for example, an industrial product. In the present exemplary embodiment, the target object is an electronic component such as an integrated circuit (IC).

Note that the target object may be any object such as a substrate instead of an electronic component.

Image processing device 100 is, for example, a computer such as a personal computer or a tablet terminal. Specifically, for example, image processing device 100 is realized by a communication interface for communicating with IF device 200 and robot 300, a nonvolatile memory in which a program is stored, a volatile memory which is a temporary storage area for executing the program, an input and output port for transmitting and receiving signals, a processor for executing the program, and the like. The communication interface may be realized by a connector or the like to which a communication line is connected so as to enable wired communication, or may be realized by an antenna, a wireless communication circuit, or the like so as to enable wireless communication.

Image processing device 100 includes learning part 110, controller 120, and storage 130.

Learning part 110 is a processing part that learns an image using deep learning. Specifically, learning part 110 causes the learning model stored in storage 130 to perform deep learning by using an image.

Learning part 110 includes feature amount extraction part 111, gaze region calculator 112, reconfiguration part 113, and operation learning part 114.

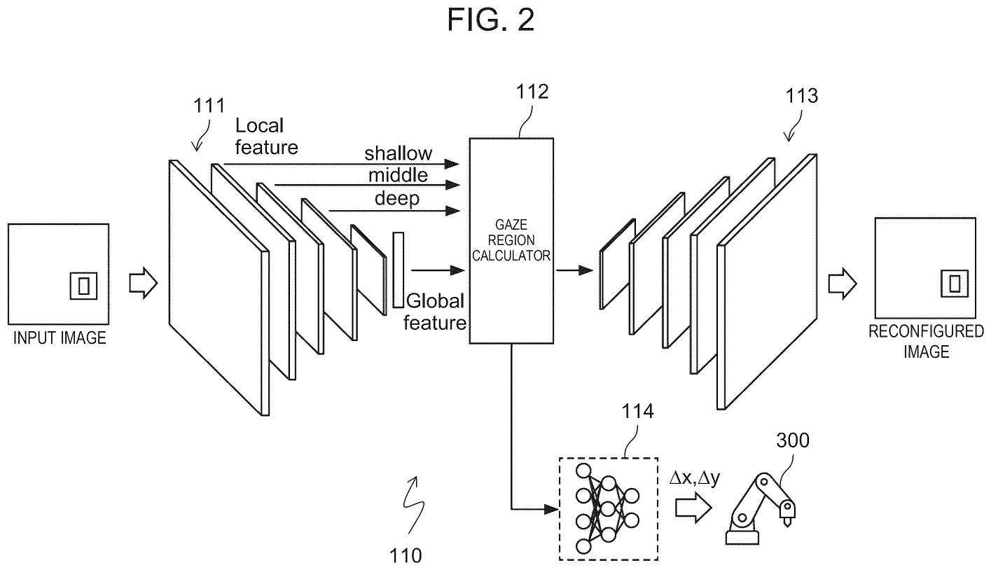

FIG. 2 is a diagram for explaining learning part 110 according to the exemplary embodiment.

Feature amount extraction part 111 is a processing part that extracts a feature amount in an image (for example, the input image in FIG. 2). Feature amount extraction part 111 is, for example, a middle layer having a multilayer structure in deep learning, and extracts a feature amount in each layer. For example, feature amount extraction part 111 extracts the first feature amount in the image in the first layer, and extracts the second feature amount different from the first feature amount in the second layer different from the first layer in the deep learning.

The number of layers in the multilayer structure may be three or more, and may be arbitrarily determined.

The feature amount is, for example, a characteristic portion (that is, the feature point) such as a corner portion or a straight line portion of the target object appearing in the image. For example, feature amount extraction part 111 extracts a first corner portion of the target object appearing in the image as the first feature amount, and extracts a second corner portion different from the first corner portion of the target object appearing in the image as the second feature amount.

Note that the feature amount may be arbitrarily determined, such as chromaticity or luminance.

Gaze region calculator 112 is a processing part that outputs the feature amount extracted by feature amount extraction part 111 to reconfiguration part 113 and operation learning part 114.

Reconfiguration part 113 is a processing part that generates an image (reconfigured image in FIG. 2) on the basis of the feature amount extracted by feature amount extraction part 111. Learning part 110 optimizes the learning model using the difference between the input image and the reconfigured image.

Operation learning part 114 is a processing part that generates control information on control of the operation of robot 300 on the basis of the feature amount extracted by feature amount extraction part 111. Robot 300 is, for example, an industrial machine that picks up a target object such as a part. For example, based on the feature amount extracted by feature amount extraction part 111, operation learning part 114 causes the learning model that receives the feature amount as an input and outputs information indicating the operation of robot 300 to learn the optimum operation of the robot so that robot 300 can appropriately pick up the target object.

As a result, for example, in a case where an image showing the target object is input to learning part 110, a learned learning model for robot 300 to perform appropriate processing on the target object shown in the image is generated on the basis of the image.

Note that the image and the annotation information for the learning model to perform learning may be stored in advance in storage 130. In addition, a learned learning model may be stored in storage 130 in advance.

Furthermore, the learning model of operation learning part 114 that outputs information for controlling the motion of robot 300 may be a learning model using reinforcement learning, a learning model that infers pose information of a hand of robot 300, or the like.

Furthermore, in learning, for example, a graphics processing unit (GPU) is used as hardware. Furthermore, the inference is not limited to, for example, the GPU, and a central processing unit (CPU) may be used.

Referring again to FIG. 1, controller 120 is a processing part that performs various types of processing executed by image processing device 100. Specifically, controller 120 controls IF device 200 and robot 300.

For example, controller 120 is realized by one or more processors.

Controller 120 includes acquisition part 121, converter 122, display controller 123, reception part 124, calculator 125, distance controller 126, and output part 127.

Acquisition part 121 is a processing part that acquires various types of information used by controller 120. For example, acquisition part 121 acquires a first feature amount of each of the first image and the second image extracted in the first layer in the deep learning and a second feature amount of each of the first image and the second image extracted in the second layer different from the first layer in the deep learning.

Converter 122 is a processing part that converts a plurality of feature amounts extracted by feature amount extraction part 111. For example, converter 122 converts the plurality of feature amounts extracted by feature amount extraction part 111 into information including information on the position of the feature amount in the image.

Display controller 123 is a processing part that controls display 220 included in IF device 200. Specifically, display controller 123 controls the image displayed by display 220. For example, display controller 123 superimposes and displays the first feature amount information on the first feature amount and the second feature amount extracted from the first image on the first image, and superimposes and displays the second feature amount information on the first feature amount and the second feature amount extracted from the second image on the second image.

The first image is, for example, an image that has been learned by learning part 110, and the second image is, for example, an image that has not been learned by learning part 110 (that is, an image that has not yet been learned by learning part 110).

Furthermore, the feature amount information is, for example, information indicating a position where the feature amount is extracted (that is, a position of the feature point). For example, the first feature amount information is information indicating the position of each of the first feature amount and the second feature amount in the first image, and the second feature amount information is information indicating the position of each of the first feature amount and the second feature amount in the second image.

Note that both the first image and the second image may be unlearned images in learning part 110.

A specific example of the image displayed on display 220 by display controller 123 will be described later.

Reception part 124 is a processing part that receives necessity of relearning using at least one of the first image and the second image in learning part 110. Reception part 124 receives a user's operation via operation part 210, for example.

For example, learning part 110 performs relearning by using at least one of the first image and the second image when reception part 124 receives an instruction that relearning is necessary from the user via operation part 210, and does not perform relearning when receiving an instruction that relearning is not necessary. For example, the user views the image displayed on display 220, determines whether or not to cause relearning, and inputs necessity of relearning using operation part 210.

For example, when reception part 124 receives an instruction that requires relearning, learning part 110 performs relearning using the first feature amount information and the second image.

The second image is, for example, an image in which the same target object as the target object appearing in the first image appears in the same attitude and angle. That is, the first feature amount information is used as the annotation information of the second image.

Note that reception part 124 may receive the necessity of relearning for each image.

Furthermore, reception part 124 may receive selection of an image (for example, the first image) to be displayed on display 220.

Furthermore, reception part 124 may receive selection (designation) of a setting file to be described later including information for determining from which layer feature amount extraction part 111 extracts the feature amount.

Furthermore, for example, the necessity of relearning may be automatically determined on the basis of the first image and the second image.

Calculator 125 is a processing part that calculates similarity between the first feature amount information and the second feature amount information. In this case, for example, learning part 110 determines the necessity of relearning using at least one of the first image and the second image on the basis of the similarity.

The similarity is, for example, a value calculated from a distance of a position where each feature amount is extracted.

For example, learning part 110 performs relearning using at least one of the first image and the second image when the similarity is less than a predetermined threshold, and does not perform relearning when the similarity is equal to or greater than the predetermined threshold.

The threshold may be arbitrarily determined. Furthermore, the similarity may be calculated by an arbitrary method.

Distance controller 126 is a processing part that controls the distance between imaging part 310 and the target object. For example, in a case where an image showing a target object is input to learning part 110 (more specifically, the learned learning model), controller 120 causes robot 300 to perform predetermined processing on the target object shown in the image on the basis of the image. Imaging part 310 is a camera that generates the image by photographing a target object. For example, distance controller 126 controls the distance between imaging part 310 and the target object by operating mechanism part 320 that supports imaging part 310 so that imaging part 310 that images the target object can image the target object at an appropriate position. As described above, for example, at least one of the first image and the second image may be an image that has not been learned by learning part 110 and may be an image generated by imaging part 310 photographing a target object.

Note that distance controller 126 may control the distance between imaging part 310 and the target object by operating mechanism part 320 that supports the target object.

Output part 127 is a processing part that outputs control information on control of the operation of robot 300 that performs predetermined processing on the target object on the basis of the image generated by imaging part 310 photographing the target object.

The control information is, for example, information including an instruction to cause robot 300 to perform predetermined processing. For example, the image generated by imaging part 310 is input to learning part 110. Furthermore, the feature amount is extracted from the image by feature amount extraction part 111, and the control information is generated by operation learning part 114 on the basis of the feature amount. Output part 127 outputs the control information generated in this manner to robot 300. As a result, robot 300 performs predetermined processing on the basis of the control information.

As described above, for example, the second image is an image that has not been learned by learning part 110 and is an image generated by imaging part 310 photographing a target object. More specifically, the second image is, for example, an image generated by imaging a target object in real time. Output part 127 outputs control information on control of the operation of robot 300 that performs predetermined processing on the target object on the basis of the second image.

Note that feature amount extraction part 111, gaze region calculator 112, reconfiguration part 113, operation learning part 114, acquisition part 121, convertor 122, display controller 123, reception part 124, calculator 125, distance controller 126, and output part 127 may be realized by, for example, a common processor or may be realized by independent processors.

Storage 130 is a storage device that stores a program executed by each processing part of learning part 110 and controller 120 to perform each processing, information necessary for the processing, a learning model, an image, and the like. Storage 130 is realized by, for example, a hard disk drive (HDD), a semiconductor memory, or the like.

IF device 200 is a user interface device used by the user, and IF device 200 includes, for example, operation part 210 and display 220.

Operation part 210 is a user interface that receives a user's operation. Operation part 210 is realized by any one of a mouse, a keyboard, a touch panel, a hardware button, and the like, or a combination of some of these.

Display 220 is a display device that displays an image under the control of image processing device 100 (more specifically, display controller 123). Display 220 displays, for example, two or more images. Display 220 is realized by, for example, a display device such as a liquid crystal panel or an organic electro luminescence (EL) panel.

Note that operation part 210 and display 220 may be integrally realized by a touch panel display or the like.

Robot 300 is a machine that performs predetermined processing on a target object. For example, robot 300 is an industrial machine, and performs processing such as picking up a component that is a target object and mounting the component on a substrate. Robot 300 includes, for example, imaging part 310 and mechanism part 320.

Imaging part 310 is a camera that generates an image by imaging a target object. Imaging part 310 is, for example, an RGB camera (camera capable of detecting red, green, and blue), and is realized by a complementary metal oxide semiconductor (CMOS) image sensor or the like.

Mechanism part 320 is a drive mechanism that performs predetermined processing on a target object, such as moving the position of imaging part 310 or picking up the target object. For example, mechanism part 320 is realized by, for example, a mechanism such as a robot arm and an end effector (EE). The EE is selected according to the task or the target object of robot 300, for example, the gripper and the attraction EE.

### [Specific Example of Image]

Next, a specific example of an image displayed on display 220 will be described. In the following first to fifth examples, the first image will be described as an image that has been learned by learning part 110, and the second image will be described as an image that has not been learned by learning part 110. For example, the second image is an image generated by imaging part 310 imaging a target object in real time. Further, the position of the first feature amount appearing in the image is indicated by “circle” (∘), and the position of the second feature amount appearing in the image is indicated by “cross” (x). That is, ∘ and x superimposed and displayed on the image are examples of the feature amount information.

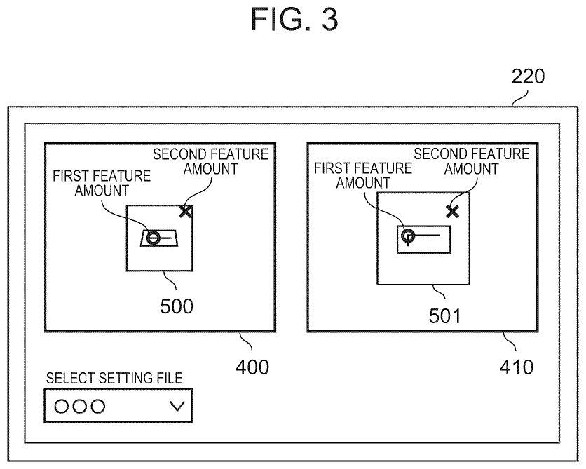

FIG. 3 is a diagram for describing a first example of an image displayed on display 220 according to the exemplary embodiment.

In the first example, first image 400 and second image 410 are displayed on display 220. Target object 500 is shown in first image 400, and target object 501 of an individual different from target object 500 is shown in second image 410.

As illustrated in FIG. 3, display controller 123 causes display 220 to display an image in which the first feature amount information on the first feature amount and the second feature amount extracted from first image 400 is superimposed and displayed on first image 400. In addition, display controller 123 causes display 220 to display an image in which the first feature amount extracted from second image 410 and the second feature amount information on the second feature amount are superimposed and displayed on second image 410. For example, display controller 123 causes display 220 to display first image 400 and second image 410 having the feature amount information superimposed thereon side by side.

As a result, the user can easily compare first image 400 and second image 410. In addition, it is easy to see whether or not the position of the feature amount extracted from second image 410 that is an image not learned by learning part 110 is close to the position of the feature amount extracted from first image 400 that is an image learned by learning part 110. That is, it is easy to compare the position of the feature amount of first image 400 in which the feature amount is considered to be appropriately extracted with the position of the feature amount of second image 410 in which whether or not the feature amount is appropriately extracted is unknown. Therefore, the user can easily determine whether or not to cause learning part 110 to learn (that is, relearn) second image 410 by checking the image displayed on display 220.

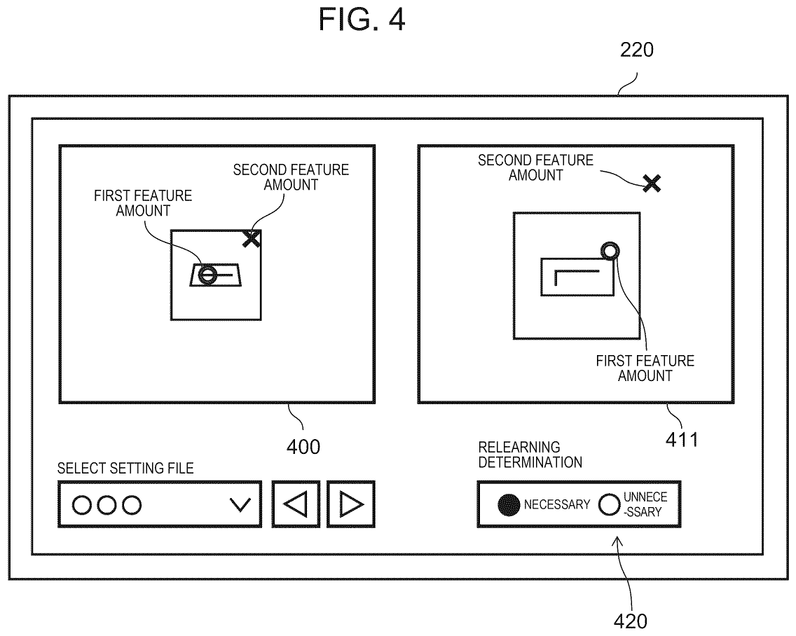

FIG. 4 is a diagram for describing a second example of an image displayed on display 220 according to the exemplary embodiment.

In the second example, display 220 displays first image 400, second image 411, and reception image 420.

As in the case of the second feature amount superimposed and displayed on second image 411, in a case where the position where the feature amount is extracted is obviously different from the second feature amount superimposed and displayed on first image 400, it is considered that the feature amount is not appropriately extracted from second image 411. Therefore, it is considered that it is better to cause learning part 110 to relearn second image 411. Therefore, for example, the user operates operation part 210 to cause learning part 110 to relearn second image 411.

Reception image 420 is an image for receiving an instruction from the user. For example, the user operates operation part 210 to check “necessity of relearning determination” in reception image 420. As a result, for example, learning part 110 causes learning part 110 to relearn second image 411. As described above, for example, according to image processing device 100, in a case where the feature amount in the unlearned image is different from the feature amount in the learned image, the user can qualitatively make a determination such as relearning, and determine whether or not relearning is possible.

Note that, in a case where relearning is performed, display 220 may display an image on which feature amount information on the feature amount extracted by learning part 110 after the relearning is superimposed and displayed.

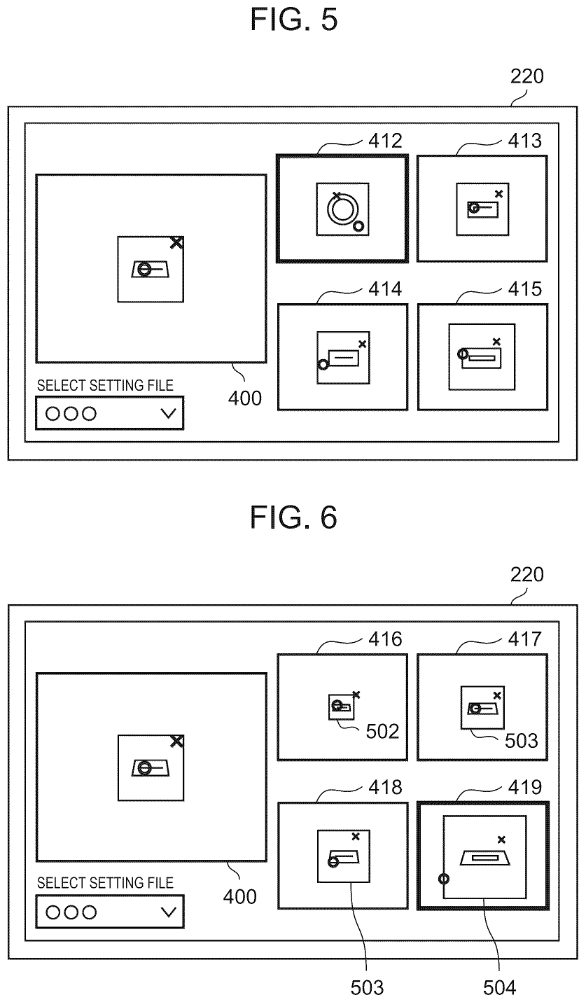

FIG. 5 is a diagram for describing a third example of an image displayed on display 220 according to the exemplary embodiment.

In the third example, display 220 displays first image 400 and four second images (second images 412, 413, 414, and 415). In second image 412, second image 413, second image 414, and second image 415, for example, target objects of different individuals are shown.

As described above, the number of second images displayed on display 220 may be arbitrary. Similarly, the number of first images displayed on display 220 may be arbitrary. In addition, the sizes, positions, and the like of the first and second images displayed on display 220 may be arbitrarily set.

Furthermore, the plurality of second images displayed on display 220 may be a plurality of second images in which target objects of different individuals appear, or may be a plurality of second images each having the same individual appearing therein and generated, for example, with the distance between imaging part 310 and the target object changed.

FIG. 6 is a view for describing a fourth example of the image displayed on display 220 according to the exemplary embodiment.

In the fourth example, first image 400 and four second images (second images 416, 417, 418, and 419) are displayed on display 220. Target object 502 is shown in second image 416, target object 503 is shown in second image 417, target object 504 is shown in second image 418, and target object 505 is shown in second image 419. Also, for target objects 502, 503, 504, and 505, target object 502 is the smallest, target object 503 is larger than target object 502, target object 504 is larger than target object 503, and target object 505 is larger than target object 504. For example, display controller 123 displays the plurality of second images side by side in the order of the size of the target object appearing in the second image. Specifically, acquisition part 121 acquires the first feature amount and the second feature amount of each of the plurality of second images in which the target objects having different sizes are shown, and display controller 123 displays the plurality of second images in which the second feature amount information is superimposed and displayed on each of the plurality of second images in order of the size of the target object shown in the second image.

Note that the size may be in descending order or in ascending order. For example, display controller 123 calculates the circumscribed rectangle of the target object shown in the image, and calculates the area of the calculated circumscribed rectangle to calculate the size of the target object shown in the image. Information indicating the size of the target object shown in the image may be stored in storage 130.

The plurality of second images may be displayed on display 220 in the order selected by the user, for example.

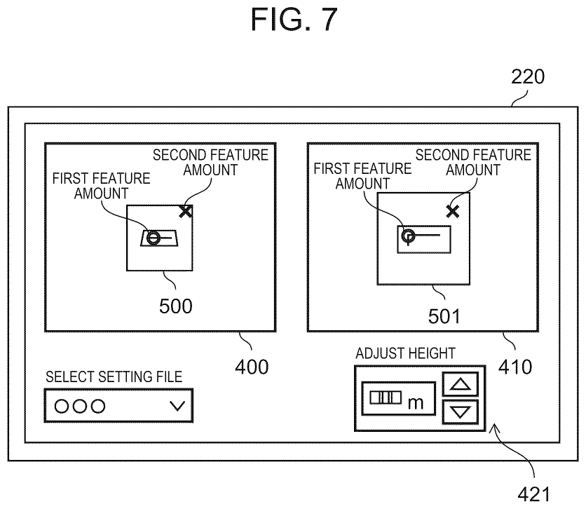

FIG. 7 is a view for describing a fifth example of the image displayed on display 220 according to the exemplary embodiment.

In the fifth example, display 220 displays first image 400, second image 410, and reception image 421.

Reception image 421 is an image for receiving an instruction from the user. For example, the user operates operation part 210 to input a numerical value in “height adjustment” in reception image 421. As a result, for example, distance controller 126 controls mechanism part 320 so that imaging part 310 and the target object are at the distance of the input numerical value. For example, in a case where the distance is the numerical value, imaging part 310 generates an image by imaging the target object and outputs the image to image processing device 100. Image processing device 100 extracts a feature amount from the image, superimposes feature amount information on the feature amount on the image, and displays the feature amount information on display 220.

As a result, the user can quickly confirm the image in a case where the distance between imaging part 310 and the target object is changed and the feature amount information on the feature amount of the image.

### [Processing Procedure]

Subsequently, a processing procedure of image processing device 100 according to the exemplary embodiment will be described.

### <Display Control>

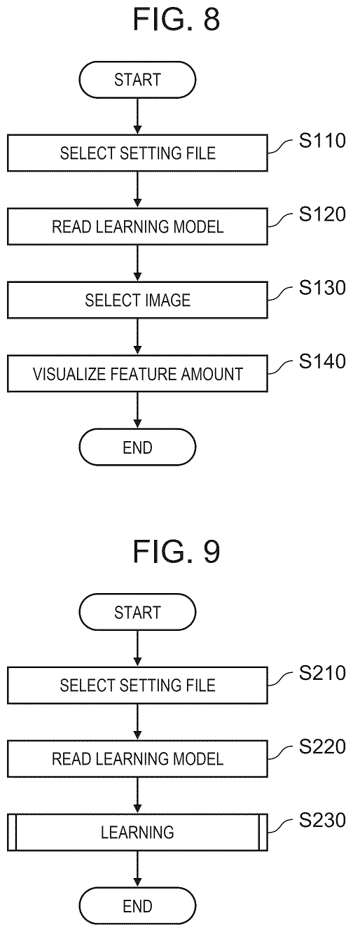

FIG. 8 is a flowchart illustrating a processing procedure of image display processing of image processing device 100 according to the exemplary embodiment. In the flowchart illustrated in FIG. 8, it is assumed that a learned learning model and an image learned by the learning model are stored in storage 130.

First, reception part 124 receives selection of a setting file (S110). For example, the user checks “setting file selection or the like of the image displayed on display 220 illustrated in FIG. 3, and operates operation part 210 to select a desired setting file. As a result, reception part 124 receives the selection of the setting file from the user.

The setting file is information including various parameters necessary for learning the learning model and parameters necessary for visualizing the feature amount, that is, when the feature amount information is superimposed on the image and displayed on display 220. These parameters include, for example, information indicating the model name of the learning model, the name of the layer to be visualized in the learning model, the number of layers in the learning model, the number of epochs, the learning rate, the size of the input image, and the like.

Next, learning part 110 reads the learning model learned according to the parameter indicated by the selected setting file (S120). That is, learning part 110 can extract the feature amount from the image using the learning model or cause the learning model to relearn.

Next, learning part 110 selects an image (S130). For example, learning part 110 selects an image learned by learning part 110 and an unlearned image from among a plurality of images stored in storage 130.

Note that an image to be selected may be arbitrary, and is not particularly limited. For example, reception part 124 may receive image selection from the user via operation part 210. Furthermore, the image to be selected may be an image generated in real time by imaging part 310.

Next, display controller 123 visualizes the feature amount extracted from the selected image (S140). Specifically, learning part 110 receives the selected image as an input, and outputs the feature amount extracted from the image. Converter 122 generates, for example, the feature amount information by converting the output feature amount, and display controller 123 superimposes the generated feature amount information on the image and causes display 220 to display the same.

For example, feature amount extraction part 111 extracts a feature amount from a layer specified in the setting file. For example, converter 122 acquires (calculates) a position (also referred to as a position feature amount) in the image from which the feature amount is extracted on the basis of the extracted feature amount. Note that, in acquiring the position feature amount, converter 122 may use only the feature amount (Local feature illustrated in FIG. 2) of the intermediate layer in the middle layer, or may use both the feature amount (Global feature illustrated in FIG. 2) obtained in the intermediate layer and the last layer. The use of both is more effective than the use of only the feature amount of the intermediate layer because both the local feature and the global feature of the input image are used to acquire the position feature amount. Converter 122 generates a weighted mask of the feature amount. For example, Spatial Softmax, a sigmoid function, or the like is used to generate the mask. Spatial Softmax is represented by the following Formula (1).

$$[ Mathematical Formula 1 ]$$

$${y}_{c , i , j} = \frac{{e}^{{x}_{c , i , j}}}{{\sum }_{{i}^{′} , {j}^{′}} {e}^{{x}_{c , {i}^{′} , {j}^{′}}}} \qquad ( 1 )$$

Note that yc, i, j represents an output, xc, i, j represents an extracted feature amount, i, j represents a pixel, and c represents a channel. For example, converter 122 acquires, as the position feature amount, a value obtained by multiplying and adding the weighted mask to a value obtained by mapping the resolution of the local feature amount to −1 to +1.

### <Deep Learning>

FIG. 9 is a flowchart illustrating a processing procedure of learning processing of image processing device 100 according to the exemplary embodiment.

First, reception part 124 receives selection of a setting file (S210).

Next, learning part 110 reads the learning model learned according to the parameter indicated by the selected setting file (S220).

Next, learning part 110 learns the learning model that has been read (S230). The learning model in which learning is performed here may be relearning by a learned learning model or may be an unlearned learning model. The image used for learning may be selected by learning part 110, may be selected by the user, or may be arbitrarily selected.

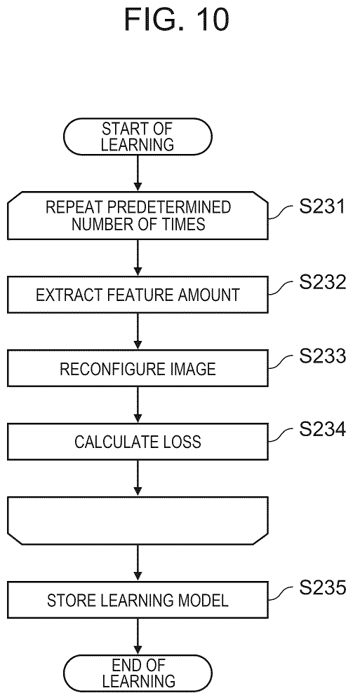

FIG. 10 is a flowchart illustrating a specific example of a processing procedure of learning processing of image processing device 100 according to the exemplary embodiment. Specifically, FIG. 10 is a flowchart illustrating details of step S230 illustrated in FIG. 9.

Learning part 110 performs learning by repeating the processing of steps S232 to S234 a predetermined number of times (S231). That is, learning part 110 causes the learning model to learn by causing the learning model to repeatedly perform the processing of steps S232 to S234 a predetermined number of times.

The predetermined number of times may be arbitrarily determined in advance, and is not particularly limited. For example, the information indicating the predetermined number of times is included in the setting file.

First, feature amount extraction part 111 extracts a feature amount from the input image (S232).

Next, reconfiguration part 113 reconfigures an image from the extracted feature amount (S233). For example, reconfiguration part 113 generates a reconfigured image so as to generate the same image as the input image.

Next, learning part 110 (for example, a loss calculator (not illustrated)) calculates a loss by calculating a difference between the input image and the reconfigured image (S234). For example, learning part 110 changes various parameters of the learning model on the basis of the calculated loss, for example, so as to reduce the loss. By repeatedly performing these processing, the learning model is optimized to appropriately extract the feature amount.

Next, learning part 110 stores the learning model in which learning has been performed, that is, the learned learning model or the learned learning model in which relearning has been performed, in storage 130 (S235).

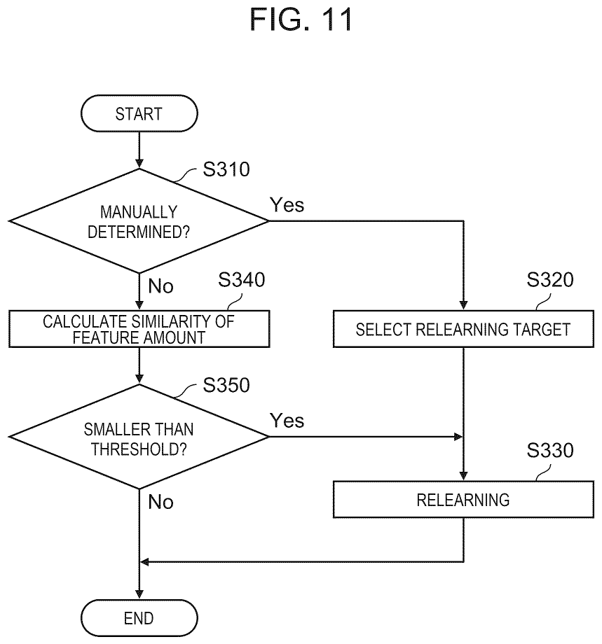

FIG. 11 is a flowchart illustrating a processing procedure for determining whether or not to execute the learning processing of image processing device 100 according to the exemplary embodiment. Specifically, FIG. 11 is a flowchart illustrating processing of determining whether or not to cause the learned learning model to execute the flow illustrated in FIG. 10 to perform relearning. Furthermore, in the present example, description will be given on the assumption that the first image is an image learned by learning part 110 and the second image is an image unlearned by learning part 110. In addition, description will be given on the assumption that the first feature amount and the second feature amount of each of the first image and the second image have already been extracted by learning part 110.

First, controller 120 determines whether or not learning part 110 manually determines whether or not to perform relearning, that is, whether or not to be determined by the user, or whether or not to be automatically determined, for example, by image processing device 100 (for example, learning part 110) (S310). That is, controller 120 has a function as a determination part. For example, reception part 124 receives whether or not learning part 110 manually determines whether or not to perform relearning via operation part 210. Information as to whether or not learning part 110 manually determines whether or not to perform relearning may be stored in advance in storage 130.

In a case where controller 120 determines that learning part 110 manually determines whether or not to perform relearning (Yes in S310), reception part 124 receives selection of an image (more specifically, the second image) to be a relearning target used when learning part 110 performs learning (S320).

Note that the number of second images to be learned by learning part 110 may be one or more, and is not particularly limited. Reception part 124 may receive selection of a plurality of images (more specifically, the second images) to be a relearning target used when learning part 110 learns.

Next, learning part 110 performs relearning using the image that has received the selection (S330). For example, learning part 110 performs relearning by performing steps S231 to S235 using the first feature amount information that is information on the feature amount extracted from the first image and the selected second image.

On the other hand, when controller 120 determines that learning part 110 automatically determines whether or not to relearn (No in S310), calculator 125 calculates similarity between the first feature amount information and the second feature amount information (S340).

Next, learning part 110 determines whether or not the calculated similarity is smaller than a predetermined threshold (S350).

When determining that the calculated similarity is smaller than the predetermined threshold (Yes in S350), learning part 110 proceeds to step S330 and performs relearning using the second image.

On the other hand, when determining that the calculated similarity is equal to or greater than the predetermined threshold (No in S350), learning part 110 ends the processing without performing relearning.

### SUMMARY

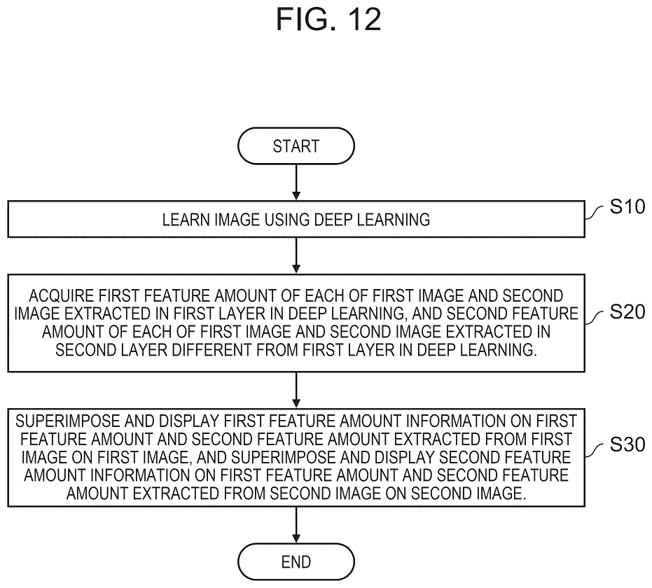

FIG. 12 is a flowchart illustrating a processing procedure of image processing device 100 according to the exemplary embodiment.

First, learning part 110 learns an image by using deep learning (S10). The image learned by learning part 110 is stored in storage 130 in advance, for example.

Next, acquisition part 121 acquires a first feature amount of each of the first image and the second image extracted in the first layer in the deep learning and a second feature amount of each of the first image and the second image extracted in the second layer different from the first layer in the deep learning (S20). For example, learning part 110 acquires the learned image as the first image from storage 130. Furthermore, for example, robot 300 transmits the second image generated by imaging part 310 imaging a target object to learning part 110. As a result, learning part 110 extracts the first feature amount and the second feature amount of each of the first image and the second image, and transmits the first feature amount and the second feature amount to controller 120.

Next, display controller 123 superimposes and displays the first feature amount information on the first feature amount and the second feature amount extracted from the first image on the first image, and superimposes and displays the second feature amount information on the first feature amount and the second feature amount extracted from the second image on the second image (S30). Specifically, display control part 123 causes display 220 to display the first image and the second image indicating the respective positions of the first feature amount and the second feature amount.

### Effects and the Like

Hereinafter, a technology obtained from the disclosure of the present specification will be exemplified, and effects and the like obtained from the exemplified technology will be described.

Technology 1 is image processing device 100 including: learning part 110 that learns an image using deep learning; acquisition part 121 that acquires a first feature amount of each of a first image and a second image extracted in a first layer in the deep learning and a second feature amount of each of a first image and a second image extracted in a second layer different from the first layer in the deep learning; and display controller 123 that superimposes and displays first feature amount information on the first feature amount and the second feature amount extracted from the first image on the first image and superimposes and displays second feature amount information on the first feature amount and the second feature amount extracted from the second image on the second image.

The first image is, for example, an image learned by learning part 110, and the second image is, for example, an image unlearned by learning part 110. In addition, the feature amount information is information on the feature amount. The feature amount information is, for example, information indicating a position where a feature amount in an image is extracted (that is, a position of a feature point).

Therefore, the user can confirm the plurality of images and the information on the feature amount of each of the images. If learning is appropriately performed by learning part 110, for example, the feature amount is extracted from an appropriate position. Here, the image in which the feature amount is not extracted from the appropriate position is considered to be an effective image for causing learning part 110 to perform relearning so that learning part 110 can extract the feature amount from the appropriate position. On the other hand, the image in which the feature amount is extracted from an appropriate position is considered to be an image having a low necessity for causing learning part 110 to perform relearning. Therefore, by displaying the image on which the feature amount information on the feature amount extracted from the image is superimposed and displayed, the user can easily select an image to be newly learned. That is, by visualizing the feature amounts extracted by the learning model in learning part 110, the user can easily narrow down data (images) to be newly learned by the learning model. For example, image processing device 100 can display the feature amounts (specifically, information indicating the position of the feature amount) generated in the plurality of middle layers of the learning model so as to be superimposed on the input image. Furthermore, according to the image processing device 100, since the feature amounts of a plurality of images can be compared, it is possible to reduce the additional learning amount of a new object and learn only data (image) that requires relearning. Furthermore, according to the image processing device 100, the user can qualitatively and quantitatively assign the presence or absence of learning from the displayed image.

Note that both the first image and the second image may be unlearned images in learning part 110.

Technology 2 is image processing device 100 according to Technology 1, further including reception part 124 that receives necessity of relearning using at least one of the first image and the second image in learning part 110.

According to this, the user can easily determine whether or not to check the image and cause learning part 110 to learn the image.

Technology 3 is image processing device 100 according to Technology 2, in which the first image is an image that has been learned by learning part 110, the second image is an image that has not been learned by learning part 110, and learning part 110 performs relearning using the first feature amount information and the second image when reception part 124 receives an instruction that requires relearning.

The first image and the second image are, for example, images in which the same target object appears in the same attitude and angle. In the case of a learned image, it is considered that the feature amount is appropriately extracted. Therefore, learning part 110 performs learning using the second image by using the first feature amount information in which the feature amount is considered to be appropriately extracted as the annotation information of the second image. As a result, it is possible to cause learning part 110 to relearn without requiring setting of the annotation information by the user.

Technology 4 is image processing device 100 according to Technology 1, further including calculator 125 that calculates similarity between the first feature amount information and the second feature amount information, in which learning part 110 determines necessity of relearning using at least one of the first image and the second image on the basis of the similarity.

An image having a high similarity is already correctly inferred by the learning model, and thus it is considered that the learning model has a low need for relearning. Therefore, for example, if the similarity is less than a predetermined threshold, learning part 110 performs relearning using at least one of the first image and the second image, and if the similarity is equal to or greater than the predetermined threshold, the learning part does not perform relearning. According to this, it is suppressed that learning is performed unnecessarily many times.

Technology 5 is image processing device 100 according to any one of Technologies 1 to 4, in which the first image is an image that has been learned by learning part 110, the second image is an image that has not been learned by learning part 110 and is an image generated by imaging part 310 photographing the target object, and image processing device 100 further includes output part 127 that outputs control information regarding control of the operation of robot 300 that performs predetermined processing on the target object on the basis of the second image.

The second image is, for example, an image generated by imaging a target object in real time. That is, for example, display controller 123 may cause display 220 to display an image selected from among the images stored in storage 130. Furthermore, for example, display controller 123 may cause display 220 to display an image generated while imaging part 310 actually photographs a target object and feature amount information on a feature amount extracted from the image. By visualizing the feature amount in real time, the user can understand an approximate operable range of mechanism part 320.

The control information is, for example, information for operating robot 300. That is, for example, output part 127 outputs the control information to robot 300 to cause robot 300 to perform an operation based on the second image. For example, robot 300 transmits, to learning part 110, a second image that is an image generated by imaging part 310 imaging the target object. Learning part 110 transmits the feature amount extracted from the second image to controller 120. Controller 120 determines how to operate mechanism part 320 on the basis of the feature amount acquired from learning part 110, and transmits (outputs) control information indicating the determined content to robot 300, thereby causing robot 300 to perform an operation based on the second image. Here, for example, in a case where the feature amount is not extracted from an appropriate position, it is conceivable that an appropriate operation is not performed by robot 300. Therefore, in such a case, the user can extract the feature amount from an appropriate position by stopping robot 300 once and causing learning part 110 to relearn the second image. That is, according to this, the user can appropriately execute the learning of learning part 110 and the operation of robot 300.

Technology 6 is image processing device 100 according to any one of Technologies 1 to 5, in which acquisition part 121 acquires the first feature amount and the second feature amount of each of the plurality of second images in which the target objects having different sizes are shown, and display controller 123 displays the plurality of second images in which the second feature amount information is superimposed and displayed on each of the plurality of second images arranged in order of the size of the target object shown in the second image.

According to this, the user can easily view the plurality of second images.

Technology 7 is image processing device 100 according to any one of Technologies 1 to 6, in which at least one of the first image and the second image is an image that has not been learned by learning part 110 and is an image generated by imaging part 310 photographing the target object, and image processing device 100 further includes distance controller 126 that controls the distance between imaging part 310 and the target object.

Here, display controller 123 causes display 220 to display, for example, an image generated while imaging part 310 actually photographs a target object and feature amount information on a feature amount extracted from the image. If imaging part 310 and the target object are not at an appropriate distance, there is a possibility that the target object appearing in the second image is not appropriately generated such as blurring due to, for example, out-of-focus of imaging part 310. Therefore, distance controller 126 controls the distance between imaging part 310 and the target object such that imaging part 310 is in focus, for example. As a result, for example, the user can confirm a change in the feature amount extracted from the image while changing the distance between imaging part 310 and the target object in real time.

Technology 8 is image processing device 100 according to any one of Technologies 1 to 7, in which the first feature amount information is information indicating a position of each of the first feature amount and the second feature amount in the first image, and the second feature amount information is information indicating a position of each of the first feature amount and the second feature amount in the second image.

According to this, the user can easily confirm the plurality of images and the positions of the feature amounts of the respective images.

Technology 9 is an image processing method including: a learning step (S10) of learning an image by using deep learning; an acquisition step (S20) of acquiring a first feature amount of each of a first image and a second image extracted in a first layer in the deep learning and a second feature amount of each of a first image and a second image extracted in a second layer different from the first layer in the deep learning; and a display control step (S30) of superimposing and displaying first feature amount information on the first feature amount and the second feature amount extracted from the first image on the first image, and superimposing and displaying second feature amount information on the first feature amount and the second feature amount extracted from the second image on the second image.

According to this, effects similar to those of image processing device 100 according to one aspect of the present disclosure are obtained.

Technology 10 is a program for causing a computer to execute the image processing method described in Technology 9.

According to this, effects similar to those of image processing device 100 according to one aspect of the present disclosure are obtained.

Note that these comprehensive or specific aspects may be achieved by a system, a method, an integrated circuit, a computer program, or a non-transitory recording medium such as a computer-readable CD-ROM, or may be achieved by any combination of the system, the method, the integrated circuit, the computer program, and the recording medium.

### Other Exemplary Embodiments, and the Like

Although the exemplary embodiment is described above, the present disclosure is not limited to the exemplary embodiment. Therefore, the constituent elements illustrated in the accompanying drawings or described in the detailed description may include not only a component essential for solving the problem but also a component non-essential for solving the problem, for the purpose of illustrating the above technique. Therefore, it should not be immediately recognized that these non-essential components are essential based on the fact that these non-essential components are described in the accompanying drawings and the detailed description.

For example, control system 600 may not include robot 300. Furthermore, for example, controller 120 may not include reception part 124, calculator 125, distance controller 126, or output part 127.

Furthermore, in the above-described exemplary embodiment, image processing device 100 is realized as a single device, but may be realized by a plurality of devices. In a case where the image processing device is realized by a plurality of devices, the components included in the image processing device described in the above exemplary embodiments may be distributed to the plurality of devices in any manner.

In addition, in the above-described exemplary embodiment, processing executed by a specific processing part may be executed by another processing part. Furthermore, the order of a plurality of processing may be changed, or a plurality of processing may be executed in parallel.

In the exemplary embodiment, each component (each processing part) may be implemented by executing a software program suitable for each component. Each component may be implemented by a CPU (or a program execution part such as a processor) reading and executing a software program recorded in a recording medium such as a hard disk or a semiconductor memory.

Further, each component may be implemented by hardware. Each of the components may be a circuit (or an integrated circuit). These circuits may constitute one circuit as a whole or may be separate circuits. Each of these circuits may be a general-purpose circuit or a dedicated circuit.

In addition, general or specific aspects of the present disclosure may be implemented by a system, an apparatus, a method, an integrated circuit, a computer program, or a non-transitory recording medium such as a computer-readable CD-ROM. In addition, the present invention may be implemented by any combination of a system, an apparatus, a method, an integrated circuit, a computer program, and a recording medium.

For example, the present disclosure may be implemented as an image processing method executed by a computer such as an image processing device. Furthermore, the present disclosure may be realized as a program for causing a computer to execute an image processing method, or may be realized as a computer-readable non-transitory recording medium in which such a program is recorded.

In addition, the present disclosure also includes a mode obtained by applying various modifications conceived by those skilled in the art to each exemplary embodiment, or a mode realized by arbitrarily combining components and functions in each exemplary embodiment without departing from the gist of the present disclosure.

### INDUSTRIAL APPLICABILITY

The image processing device, the image processing method, and the program of the present disclosure are useful as an image processing device that presents an image to a user.

### REFERENCE MARKS IN THE DRAWINGS

100 image processing device
110 learning part
111 feature amount extraction part
112 gaze region calculator
113 reconfiguration part
114 operation learning part
120 controller
121 acquisition part
122 converter
123 display controller
124 reception part
125 calculator
126 distance controller
127 output part
130 storage
200 IF device
210 operation part
220 display
300 robot
310 imaging part
320 mechanism part
400 first image
410, 411, 412, 413, 414, 415, 416, 417, 418, 419 second image
420, 421 reception image
500, 501, 502, 503, 504, 505 target object
600 control system

1. An image processing device comprising:
a learning part that learns an image by using deep learning;
an acquisition part that acquires
a first feature amount of each of a first image and a second image each extracted in a first layer in the deep learning and
a second feature amount of each of a first image and a second image each extracted in a second layer different from the first layer in the deep learning; and
a display controller that superimposes and displays first feature amount information on the first feature amount and the second feature amount extracted from the first image extracted in the first layer on the first image extracted in the first layer, and superimposes and displays second feature amount information on the first feature amount and the second feature amount extracted from the second image extracted in the second layer on the second image extracted in the second layer.

2. The image processing device according to claim 1, further comprising a reception part that receives necessity of relearning using at least one of the first image and the second image in the learning part.

3. The image processing device according to claim 2, wherein
the first image is an image learned by the learning part,
the second image is an image that has not been learned by the learning part, and
the learning part performs relearning using the first feature amount information and the second image when the reception part receives an instruction requiring relearning.

4. The image processing device according to claim 1, further comprising a calculator that calculates similarity between the first feature amount information and the second feature amount information, wherein
the learning part determines necessity of relearning using at least one of the first image and the second image on a basis of the similarity.

5. The image processing device according to claim 1, wherein
the first image is an image learned by the learning part,
the second image is an image that has not been learned by the learning part and is an image generated by an imaging part photographing a target object, and
the image processing device further includes an output part that outputs control information related to control of operation of a robot that performs predetermined processing on the target object on a basis of the second image.

6. The image processing device according to claim 1, wherein
the acquisition part acquires the first feature amount and the second feature amount of each of a plurality of the second images in which target objects having different sizes are shown, and
the display controller causes each of the plurality of second images to display the plurality of second images in which the second feature amount information is superimposed and displayed in order of one of the sizes of the target objects appearing in the second image.

7. The image processing device according to claim 1, wherein
at least one of the first image and the second image is an image that has not been learned by the learning part and is an image generated by an imaging part photographing a target object, and
the image processing device further includes a distance controller that controls a distance between the imaging part and the target object.

8. The image processing device according to claim 1, wherein
the first feature amount information is information indicating a position of each of the first feature amount and the second feature amount in the first image, and
the second feature amount information is information indicating a position of each of the first feature amount and the second feature amount in the second image.

9. An image processing method comprising:
a learning step of learning an image by using deep learning;
an acquisition step of acquiring a first feature amount of each of a first image and a second image extracted in a first layer in the deep learning and a second feature amount of each of a first image and a second image extracted in a second layer different from the first layer in the deep learning; and
a display control step of superimposing and displaying first feature amount information on the first feature amount and the second feature amount extracted from the first image on the first image, and superimposing and displaying second feature amount information on the first feature amount and the second feature amount extracted from the second image on the second image.

10. (canceled)
